(19) United States
(12) Patent Application Publication
(10) Pub. No.: US 2010/0151423 A1
(43) Pub. Date: Jun. 17, 2010

(54) TEMPORARY RESTORATIONS AND RELATED METHODS

(76) Inventors: Roger S. Ranck, Ambler, PA (US); Stephen Hogan, Wilmington, DE (US); Anatoli Krivoruk, Philadelphia, PA (US)

Correspondence Address: O'BRIEN JONES, PLLC, 1951 Kidwell Drive, Suite 550 B, Tyson's Corner, VA, 22182, US

(21) Appl. No.: 12/508,262

(22) Filed: Jul. 23, 2009

Related U.S. Application Data
(63) Continuation-in-part of application No. 12/371,563, filed on Feb. 13, 2009.
Application No. 12/371,563 is a continuation-in-part of application No. 12/332,524, filed on Dec. 11, 2008.

(51) Int. Cl. A61C 13/103

(52) U.S. Cl. 433/193; 433/215

(57) ABSTRACT

A temporary restoration or preform for use in a patient's body may comprise apical end, a coronal end opposite the apical end, and a portion configured to engage with an underlying structure for retention thereto, wherein a first portion of the preform comprises a hardened material and a remaining portion of the preform comprises a hardenable malleable material. Methods for fitting a temporary restoration in a patient and kits for making dental restorations are also disclosed.

### RELATED APPLICATION

This application is a continuation-in-part of U.S. patent application Ser. No. 12/371,563, filed Feb. 13, 2009, entitled “Components for Use with Implants and Related Methods,” the entirety of which is incorporated herein by reference. This application also is a continuation-in-part of U.S. patent application Ser. No. 12/332,524, filed Dec. 11, 2008, entitled “Fixtures for Dental implants,” the entirety of which is incorporated by reference herein.

### TECHNICAL FIELD

The present teachings relate to a temporary restorations used, for example, as temporary prosthetic parts. For example, the present teachings relate to temporary restorations for dental use, such as, for example, with either dental implants or prepared teeth in the case of crowns.

### Introduction

Implants placed in bone and/or cartilage represent a growing field of reconstruction technology for replacing parts of the body, for example, with prosthetic parts. Such implants may be secured in the bone and/or cartilage and used to anchor a prosthetic body part in position. One type of implant that has relatively widespread use includes dental implants. During dental implantation, a hole is drilled through the gingiva, the gums surrounding the root of a tooth, and/or into the jawbone. An implant, which may be, for example, made of titanium or titanium alloy, is then fixed within the hole of the jawbone. Over a period of months, the titanium implant fuses to the jawbone through a process called osseointegration. After a period of time, ranging from weeks to months, a permanent replacement tooth (sometimes referred to as a final restoration or permanent restoration) is secured relative to the implant in the patient's mouth Prior to placement of the permanent replacement tooth, a temporary replacement tooth (sometimes referred to as a temporary restoration) may be secured relative to the implant to provide some function and aesthetics in the time period before the permanent replacement tooth is in place.

For placing a temporary tooth, a so-called temporary coping can be engaged with the implant, and, if any, superstructure, such as an abutment, in the patient's mouth and a veneering material (such as, for example, an acrylic material) used to create the aesthetic outer appearance of the temporary tooth is bonded thereto with cement or other mechanical bond. This process can be done either chairside by the dentist or in a dental laboratory. Some adjustments may be made to the height, angle, and/or inter-occlusal clearance of the portion of the abutment that supports the restoration if necessary, for example, by using a bur to shave the abutment. In some approaches, a plastic temporary coping designed to provide a mechanical bond, for example, via cement or other adhesive, with the veneering material may be placed over the abutment. Again, adjustments for inter-occlusal height, clearance, and/or angle of the temporary restoration may be made if necessary. Prefabricated polycarbonate crowns or vacuum stents also may be used with a veneering material to complete fabrication of the temporary restoration.

Oftentimes a loose fit (e.g., larger space) between the temporary restoration and the abutment may be necessary in order to allow room for the temporary cement that is typically used to bond the temporary restoration (i.e. the temporary coping portion of the temporary restoration). If enough space is not provided, excessive hydraulic pressures from the cement may occur when seating the temporary restoration, which could lead to inaccurate seating of the restoration upon hardening of the cement.

For fabricating temporary restorations in the form of crowns used in conjunction with prepared teeth rather than with dental implant components, it is known to use a product known as ProTemp™ Crown sold by 3M, which comprises a hardenable, self-supporting material in the general shape of a tooth for use as a crown. The material is malleable at room temperature, which enables the dentist to manipulate the occlusal, buccal, and lingual surfaces of the material to fit the patient's mouth. The material can then be hardened by curing the material, and the temporary tooth is then bonded to the prepared tooth in a conventional manner, such as cementing the tooth to the prepared tooth.

Based on some of the aforementioned issues, it may be desirable to provide a system that improves the accuracy and precision of the fit of a temporary restoration (including for use with dental implants or with prepared teeth) to underlying structures and relative to the gumline and other teeth in a patient's mouth, reduces the overall time spent on creating and fitting the temporary restoration, and/or improves the strength of the connection between the temporary restoration and the underlying structure. To assist in achieving one or more of these desirable features, it further may be desirable to provide a temporary restoration that provides a relatively tight and precise fit to an underlying structure, such as an abutment or prepared tooth, rather than a looser fit provided when using some conventional techniques and their component parts. It also may be desirable to provide temporary restorations that are configured to provide a precise and sufficiently strong mechanical engagement with an underlying structure and that eliminate the need to use cement and/or other bonding material.

### SUMMARY

The present teachings may satisfy one or more of the above-mentioned desirable features and/or solve one or more of the above-mentioned problems. Other features and/or advantages may become apparent from the description that follows.

Various exemplary embodiments of the present teachings relate to a temporary restoration preform for use in a patient's body, comprising an apical end, a coronal end opposite the apical end, and a portion configured to engage with an underlying structure for retention thereto, wherein a first portion of the preform comprises a hardened material and a remaining portion of the preform comprises a hardenable malleable material.

Other embodiments of the present teachings relate to a method for fitting a temporary restoration in a patient, comprising providing a temporary restoration preform comprising an apical end, a coronal end, and a portion configured to engage an underlying structure for retention thereto, wherein the apical end comprises a hardened material and the coronal end comprises a hardenable malleable material; engaging the temporary restoration preform with the underlying structure; and hardening the hardenable malleable material to form a temporary restoration in a patient's mouth.

Various embodiments according to the present teachings also relate to a method for fitting a temporary restoration in a patient, comprising providing a temporary restoration preform comprising a hardenable malleable material wherein the temporary restoration preform comprises an apical end, a coronal end, and a hollow cavity configured to receive an abutment; inserting an abutment comprising a retention feature on an outer surface thereof into the hollow cavity; adjusting the hardenable malleable material about the retention feature of the abutment to form a complementary retention feature on an inner engagement surface defining the hollow cavity; and at least partially hardening the hardenable malleable material.

Embodiments of the present teachings also relate to a kit for making dental restorations, the kit comprising an abutment comprising an implant engaging portion and a component supporting portion, the implant engaging portion being configured to engage with a dental implant and the component supporting portion comprising at least one retention feature disposed on an outer peripheral surface of the component supporting portion; and a temporary restoration preform comprising a hardened malleable material, wherein the temporary restoration preform comprises an apical end, a coronal end, and a hollow cavity configured receive the component supporting portion.

Additional objects and/or advantages of the present teachings will be set forth in part in the description which follows, and in part will be obvious from the description, or may be learned by practice of the present teachings. Those objects and advantages may be realized and attained by means of the elements and combinations particularly pointed out in the appended claims.

It is to be understood that both the foregoing general description and the following detailed description are exemplary and explanatory only and are not restrictive of the present teachings or claims. Rather, the claims are intended to cover a broad scope, including equivalents.

The accompanying drawings, which are incorporated in and constitute a part of this specification, illustrate exemplary embodiments of the present teachings and together with the description, serve to explain certain principles.

### BRIEF DESCRIPTION OF THE DRAWINGS

FIG. 1 is a perspective view of an exemplary embodiment of a temporary restoration preform in accordance with the present teachings;

FIG. 2 is a cross-sectional view of the temporary restoration preform of FIG. 1 taken through line 2-2;

FIG. 3 is a perspective view of another exemplary embodiment of a temporary restoration preform in accordance with the present teachings;

FIG. 4 is a cross-sectional view of the temporary restoration preform of FIG. 3 taken through line 4-4;

FIG. 5 is a perspective view of an exemplary embodiment of an abutment in accordance with the present teachings;

FIG. 6 is a cross-sectional view of an exemplary embodiment of a temporary restoration engaged with an abutment in accordance with the present teachings;

FIG. 7 is a cross-sectional view of an exemplary embodiment of a temporary restoration engaged with a prepared tooth in accordance with the present teachings;

FIG. 8 is a schematic representation of an exemplary embodiment of a temporary restoration preform in a patient's mouth prior to adjusting in accordance with the present teachings;

FIG. 9 is a schematic representation of an exemplary embodiment of occlusal adjustment of a temporary restoration preform in accordance with the present teachings;

FIG. 10 is a schematic representation of an exemplary embodiment of curing a temporary restoration in accordance with the present teachings;

FIG. 11 is a cross-sectional view of an exemplary embodiment of a chemically bonded temporary restoration engaged with an abutment in accordance with the present teachings;

FIG. 12 is a cross-sectional view of an exemplary embodiment of a temporary restoration engaged with an abutment in accordance with the present teachings;

FIG. 13 is cross-sectional view of an exemplary embodiment of an abutment engaged with an implant in accordance with the present teachings;

FIG. 14 is a cross-sectional view of an exemplary implant that may be used in accordance with the present teachings;

FIG. 15 is a coronal view of the implant of FIG. 14;

FIG. 16 is a cross-sectional view of an exemplary preform in accordance with the present teachings; and

FIG. 17 is a cross-sectional view of the preform of FIG. 16 engaged with the implant of FIG. 14.

### DETAILED DESCRIPTION OF VARIOUS EXEMPLARY EMBODIMENTS

Reference will now be made in detail to various exemplary embodiments of the present teachings, examples of which are illustrated in the accompanying drawings. Wherever possible, the same reference numbers will be used throughout the drawings to refer to the same or like parts.

As used herein, those having ordinary skill in the art are familiar with the meaning of the terms “apical,” “coronal,” “occlusal,” “buccal,” and “lingual.” As used herein, “apical” refers to a direction toward the jaw bone, or toward root tips of teeth. If the term “apical” is used to refer to a portion of a component, it refers to the portion of the component that would be facing, closer to, and/or in a direction of the jaw bone and/or root tips if the component were placed in an operational position in a patient's mouth. The term “coronal” refers to a direction opposite the jaw bone and toward the crowns of teeth. If the term “coronal” is used to refer to a portion of a component, it may refer to the portion of the component that would be facing, closer to, and/or in the direction of the crown portion of teeth if the component were placed in an operational position in a patient's mouth. The term “occlusal” refers to the biting surface of a tooth. The term “buccal” refers to the surface of a tooth that faces the patient's cheek. The term “lingual” refers to the surface of a tooth that faces the patient's tongue.

As used herein, the term “preform,” “temporary restoration preform” and variants thereof may include a structure that is configured as a starting structure that is intended to be treated, formed, molded, shaped, and/or otherwise manipulated into a final structure. In the context of preforms used for temporary restorations, such preforms, once manipulated, may form at least part, if not all, of the final temporary restoration structure (e.g., the final temporary replacement tooth or, in the case of a bridge, multiple temporary replacement teeth). In at least some embodiments, temporary restoration preforms may have a substantially tooth-like shape that can be refined via manipulation to form a more customized appearance and fit within a patient's mouth, and ultimately be manipulated to be secured in the patient's mouth as the final temporary restoration. Exemplary embodiments of preforms in accordance with the present teachings may include preforms comprising hardened or pre-cured material, malleable material, or a combination of malleable material and hardened or pre-cured material.

As used herein, the terms “hardenable,” “curable,” and variations thereof, refer to a material's ability to be made harder than the starting material. A material may be considered curable if its hardness may be increased by a triggering source such as, for example, exposure to heat or light, such as, e.g., UV light. Hardenable materials may increase in hardness in the same way as curable materials, or, for example, by exposure to air or by the removal of moisture from the material. As used herein, the phrase “curable material” encompasses a subset of materials known as “hardenable material.”

As used herein, the phrase “underlying structure” refers to any structural element that lies in an apical position relative to another structure, such as, for example, a temporary preform. Exemplary underlying structures may include but are not limited to a prepared tooth, an abutment, a temporary coping, and an implant.

As used herein, the term “temporary restoration” is intended to include a structure that serves as a temporary prosthetic part, such as, for example, a temporary tooth. Temporary restoration, as used herein, encompasses crowns (e.g., including bridges in the case of multiple temporary replacement teeth, as is known to those skilled in the art) configured to engage with prepared natural teeth, as well as temporary replacement tooth structures that are configured to engage with dental implants with or without abutments.

The present teachings contemplate novel temporary restorations and temporary restoration techniques that rely on the use of a temporary restoration preform. It is contemplated that various exemplary embodiments of the present teachings may be used with restoration techniques where a temporary restoration preform is used to create a crown to be placed on a prepared tooth or to create a temporary restoration for engagement relative to a dental implant, for example, via an abutment. Various exemplary embodiments of the disclosed temporary restorations may improve the precision and/or accuracy of the fit with the prepared tooth or an abutment

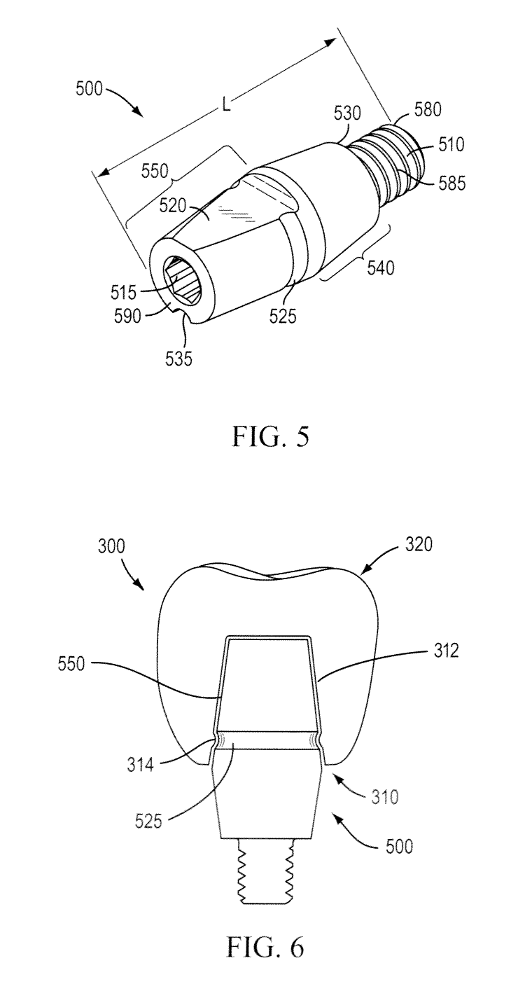

In various exemplary embodiments of the present teachings, temporary restorations in accordance with the present teachings may be secured to an abutment of a dental implant system without the use of cement or other adhesive material. An exemplary abutment that may be used in accordance with the present teachings is disclosed in U.S. patent application Ser. No. 12/371,563, which is incorporated by reference herein in its entirety and to which this application claims priority, and is illustrated in FIG. 5. Temporary restorations in accordance with the present teachings may provide a secure fit to an abutment for subsequent fitting of the temporary restoration within the patient's mouth prior to the final attachment of the temporary restoration. The temporary restoration may provide a secure fit that eliminates the need for adhesives such as cement. In various exemplary embodiments, temporary restorations of the present teachings may also simplify the process of forming a temporary restoration and/or improve patient comfort.

Various exemplary embodiments of the present teachings may be used in conjunction with an implant having a shoulder that is at the level of the tissue, or is slightly below the tissue, such as, for example, so-called “single-stage implants,” although such use is not intended to be limiting. In such cases, the shoulder on the implant may provide the finish line for the apical end of a mating component, such as, for example, a temporary restoration. In various exemplary alternative embodiments, the present teachings may be used with an implant having an implant shoulder that is “submerged,” or placed below the bone, and an abutment is provided with a shoulder portion that provides the finish line for the apical end of a mating component, such as, for example, a temporary restoration. When used in dental implant applications, it is contemplated that exemplary embodiments of the present teachings may be configured for engagement with various implant configurations, such as those used in conventional implant systems that include but are not limited to, for example, various Solid Screw and Tapered Effect Implants made by ITI Straumann, including but not limited to the 4.1 mm and 4.8 mm Solid Screw and Tapered Effect Implants, and the 4.8 mm Wide Neck Solid Screw Implant and Tapered Effect Implant; Keystone Stage-1 and XP implants; BlueSkyBio One Stage Implant w/Regular and Wide Platform, Osstem SS Implant with Solid and Excellent Solid, 3I TG implant, Zimmer's SwissPlus implant, Straumann Bone Level Crossfit Implants, Keystone Prima implants, BlueSkyBio trilobe and internal hex implants, Biomet 3I Certain and External hex implants, Zimmer OnePiece, Screw-Vent and Spline implants, Astra Tech implants, Bicon implants, and Nobel's NobelActive and Nobel Replace implants, among others. Implants with which various exemplary embodiments of the present teachings are configured to be used may also include a variety of coronal configurations for mating with abutments including, but not limited to, for example, tapered internal coronal necks (e.g., conically-tapered internal coronal necks) and/or indexed (e.g., polygonal) anti-rotational internal coronal neck features, with which those having ordinary skill in the art are familiar. Those having ordinary skill in the art will appreciate a wide variety of conventional implants and other implant structures with which the various exemplary embodiments in accordance with the present teachings may be utilized.

In various alternative exemplary embodiments, temporary restoration preforms may comprise a hollow structure configured to receive an underlying structure, such as, for example, a prepared tooth, an abutment, or a temporary coping. In other exemplary embodiments, the preforms may comprise a feature, such as a post, configured to be inserted within a complimentary opening in an underlying structure, such as, for example, an abutment or an implant, to secure the preform thereto The preform may comprise a hardenable or curable material that is malleable and self-supporting at room temperature and may be cured by heat or light, such as, for example, ultraviolet (UV) light. Preforms according to various exemplary embodiments the present teachings also may comprise a hardened material, such as a material that has been pre-cured. Various exemplary embodiments of the present teachings may also provide a preform comprising a curable, malleable portion and a pre-hardened (e.g., pre-cured) portion.

According to various methods of the present teachings, a pre-hardened portion of a temporary restoration preform may be placed in engagement with an underlying structure. The preform may be adjusted to fit within a patient's mouth and then affixed in position over the underlying structure. In embodiments wherein the preform comprises a curable, malleable portion, the adjustments may be made by molding the malleable portion, followed by curing the malleable portion to harden the material In other embodiments, the preform may be adjusted by removing part of the hardened material, for example, by grinding.

In embodiments wherein a temporary restoration preform is used in conjunction with an implant, abutment, and/or a temporary coping, the preform may comprise a combination of a prehardened portion and a malleable, hardenable portion, or may consist essentially of a curable, malleable material. The preform may either be provided to the dental professional with a pre-hardened portion, or the dental professional may pre-harden at least a portion of a hardenable, malleable temporary preform either inside or outside of the patient's mouth.

When the temporary restoration preform comprises a pre-hardened portion, the pre-hardened portion may be configured to securely engage with an implant, abutment, and/or temporary coping. For example, the implant, abutment, and/or temporary coping may comprise an engagement feature, such as, for example, a retention groove. In an exemplary embodiment, the pre-hardened portion of the temporary restoration preform may therefore comprise a complementary feature that engages the engagement feature of the implant, abutment, and/or temporary coping to provide a sufficiently secure fit thereto, for example, without the need for adhesive material, such as, for example, cement.

In methods that use a temporary restoration preform that consists essentially of a curable, malleable material, the dental professional may engage the hollow structure of the preform with the underlying structure including an implant, abutment, and/or temporary coping and mold the malleable material to securely engage the underlying structure. In embodiments where the implant, abutment, and/or temporary coping comprise a retention feature, as described above, the malleable material may be molded about the retention feature to create a complementary feature capable of securely engaging the temporary restoration preform to the underlying structure. The malleable material may be cured in situ in at least the area comprising the complementary feature. The remainder of the malleable material may be adjusted as described above either before or after curing the malleable material

According to various exemplary embodiments of the present teachings, the temporary restoration preform may be used to engage a prepared tooth. In those embodiments, a hollow structure of the temporary restoration preform may comprise a pre-hardened material that engages the prepared tooth. For example, at least an inner surface portion of the preform may be pre-cured and hardened. A hardenable, flowable material may be inserted in the hollow structure prior to engaging the preform with the prepared tooth. The hardenable, flowable material may fill in any spaces between the hollow cavity of the preform and the prepared tooth, where it may then harden. The temporary restoration preform may be adjusted and any curable, malleable material, if present, may be cured. The temporary tooth may be affixed to the prepared tooth by any conventional method, such as by cementing the temporary tooth to the prepared tooth with a temporary cement.

Various exemplary embodiments of the present teachings also contemplate a kit comprising a temporary restoration preform in accordance with exemplary embodiments of the present teachings and an abutment. The abutment may be configured for securing to or made integral with a dental implant and may include one or more retention features, for example, either indentations or protrusions, such as, for example, retention grooves, on an outer peripheral surface (e.g., an outer lateral surface) thereof and configured to engage with one or more complementary retention features, for example, indentations or protrusions, on an engagement portion of a temporary restoration. The one or more indentations or protrusions may have a radiused surface profile, meaning that the indentation or protrusion may be formed so as to present a radius of curvature.

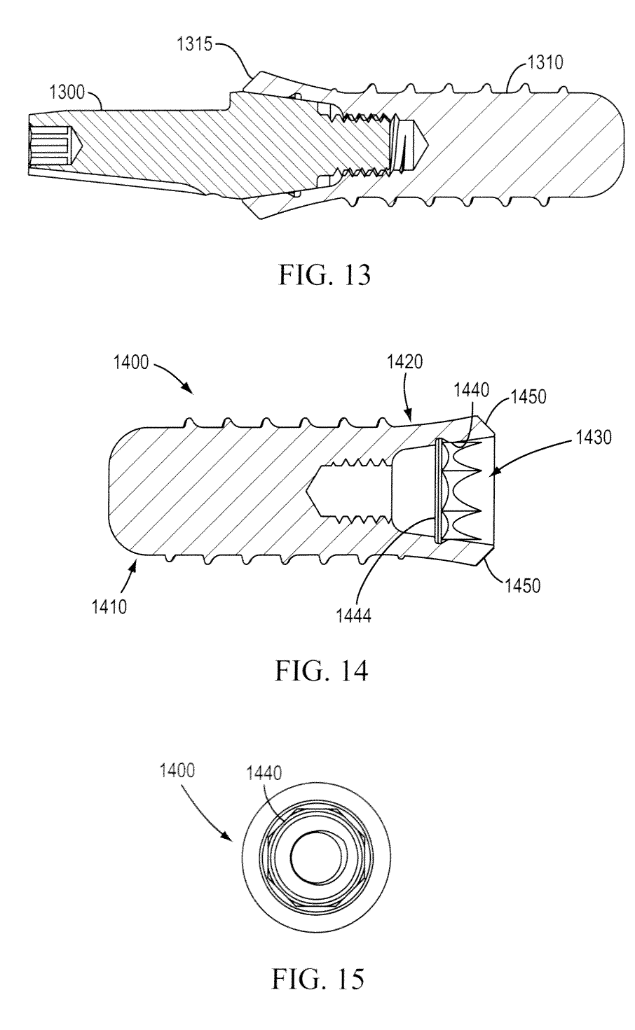

In an exemplary embodiment, as shown in FIG. 13, an abutment 1300 of the present teachings does not include a significant shoulder portion adjacent the retention groove 525 in an apical direction. In other words, the widest portion of the abutment does not extend radially beyond a shoulder 1315 of the coronal neck of an implant 1310 with which the abutment 1300 is configured to mate. Thus, abutments in accordance with various exemplary embodiments of the present teachings may permit a mechanical securement of a component (e.g., temporary restoration and/or temporary coping) to the abutment while achieving a finish line of the component with an implant shoulder. In other words, when secured to an abutment in accordance with various exemplary embodiments of the present teachings, apical ends of various components, such as, for example, temporary restorations, of the present teachings may engage the implant shoulder rather than a portion, for example, a shoulder portion, of the abutment. In an alternative exemplary embodiment, however, an abutment of the present teachings may include a shoulder portion adjacent the one or more retention features in an apical direction and that is configured to provide the finish line surface with the apical ends of components supported by the abutment.

Providing the securing (retention) engagement of the components with the abutment may facilitate placing a temporary restoration in an engaged manner in a patient's mouth. For example, since the portion of the abutment carrying the retention mechanism generally sits higher relative to the gumline (and in at least some cases is above the gumline) than the implant, engaging a temporary restoration with the abutments may be easier because less or no gingival tissue may be needed to be pushed out of the way during engagement and/or molding of the temporary restoration on the abutment. Similarly, engaging a temporary restoration comprising an engagement portion, for example, one or more indentations or protrusions, with the abutment in accordance with the present teachings may be easier because less or no gingival tissue may be needed to be pushed out of the way during expansion of the temporary restoration to achieve the retaining engagement (which may be, for example, a snap-fit engagement) between the one or more indentations or protrusions on the temporary restoration with the one or more indentations or protrusions on the abutment Moreover, dampening of tactile and/or auditory sensation may be minimized during the engagement of the temporary restoration with the abutment, thus promoting confirmation that the temporary restoration has been accurately secured. The configurations of the temporary restorations and abutments according to various exemplary embodiments of the present teachings also may require less or no bonding material (e.g., cement) when securing the temporary restorations to the abutment. For example, it may be possible to provide a sufficient retention of a temporary restoration by relying on the mechanical mating engagement (e.g., snap-fit engagement) between those structures and abutments in accordance with various exemplary embodiments, without requiring additional bonding material, such as cement or other adhesive.

The drawings included herewith as part of the specification contain various dimensions, tolerances, and/or other specifications that are not intended to be limiting of the present teachings or the scope of the claims. Rather, the dimensions, tolerances, and/or other specifications noted on the drawings represent exemplary embodiments of the various components depicted. Those having ordinary skill in the art would understand that modifications to such dimensions, tolerances and/or other specifications may be made as desired and in accordance with the present teachings without departing from the scope of the present teachings.

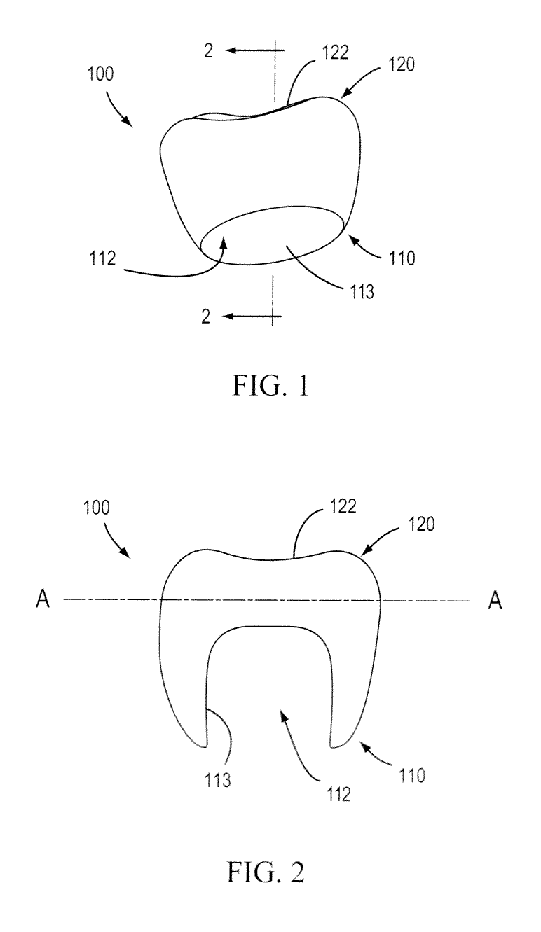

With reference now to FIGS. 1 and 2, an exemplary embodiment of a temporary restoration preform 100 for use in a dental restoration is depicted. In an exemplary embodiment, the preform 100 may be configured generally as a structure sold by 3M under the name PROTEMP™ CROWN. However, such configuration is exemplary and non-limiting and other exemplary materials for the temporary restoration preform are disclosed, for example, in U.S. Published Patent Application Nos. US 2009/0329289 and US 2003/0114553, the entire disclosures of which are hereby incorporated by reference. More specifically, the preform 100 comprises a temporary hollow structure of a substantially tooth-like shape having an apical end 110 and a coronal end 120 opposite the apical end 110. The apical end 110 defines an opening leading to a hollow cavity 112 generally shaped to receive an underlying structure, such as, for example, a prepared tooth, abutment, or a temporary coping, as will be described further below An inner engagement surface 113 defines the cavity 112. Coronal end 120 comprises occlusal surface 122.

According to at least one embodiment, the temporary restoration preform 100 may comprise a hardenable malleable material, for example, a hardenable malleable bis-acrylic material as used in the PROTEMP™ CROWN sold by 3M and/or as described in U.S. Published Patent Application Nos. US 2003/0114553 and US 2009/0032989, which are hereby incorporated by reference. The hardenable malleable material may be pliant yet self-supporting at room temperature. The malleability may allow the temporary restoration to be customized while the temporary restoration preform 100 is engaged with an underlying structure in the patient's mouth. For example, the hardenable malleable material of the temporary restoration may be molded and/or shaped, e.g., either by hand, shaping tools, or other mechanisms, to achieve a customized fit to a support in the patient's mouth, as well as a customized appearance in the patient's mouth. In at least one exemplary embodiment, the hardenable malleable material may be at least partially cured or hardened while the temporary restoration preform 100 is engaged with the underlying structure in the patient's mouth. At least partially curing the temporary restoration preform 100 in the patient's mouth may prevent the temporary restoration preform 100 from deforming if it is separated from the underlying structure while the material is still malleable.

In at least one exemplary embodiment, at least a portion of preform 100 may be pre-cured. For example, at least a portion of preform 100 may be hardened outside of the patient's mouth, such as by the manufacturer, by a dental lab technician in a dental laboratory, or by another dental professional. In another example, at least a portion of preform 100 may be hardened while the preform 100 is engaged with an underlying structure in the patient's mouth. How much of the preform 100 is hardened depends on the desired properties of the preform and as such would be within the knowledge of one skilled in the art. For example, in FIG. 2, the apical end 120 of preform 100 below line A-A may be hardened while the coronal end 110 of preform 100 and portions above line A-A may be malleable, which may provide a stable engagement with the underlying structure while allowing the malleable coronal end 120 to be adjusted before hardening the material. Alternatively, coronal end 110 may be hardened and apical end 120 may comprise a hardenable malleable material.

In according with the present teachings, the preform 100 may include a hardened material. When preform 100 is entirely a hardened material, preform 100 may be adjusted by any known means, such as by grinding or polishing, for example.

In at least one embodiment where the temporary restoration preform at least partially comprises a hardened material, an additional hardenable material may be used to form a closer fit between the preform and the underlying structure. For example, a hardenable flowable material, such as, for example, PROTEMP™ PLUS sold by 3M, may be applied to the hollow cavity 112 prior to engaging the preform 100 to the underlying structure. The hardenable flowable material may fill in any spaces or gaps present between the preform 100 and the underlying structure to provide a tight engagement. In at least one embodiment, the hardenable flowable material may be selected so that it forms a secure bond to the preform once the hardenable flowable material hardens. For example, the hardenable flowable material may adhere to the preform, or the hardenable flowable material may form a chemical bond with the preform. In at least one embodiment, the hardenable flowable material and preform are chosen from materials capable of forming a chemical bond. In one exemplary embodiment, the hardenable flowable material and the preform may be chosen from bis-acrylic materials, such as PROTEMP™ PLUS and PROTEMP™ CROWN, respectively.

The temporary restoration preform 1 00 may be adapted for use with an underlying structure, such as, for example, a prepared tooth, an implant, an abutment, or a temporary coping. In an exemplary embodiment in accordance with the present teachings, the preform, such as the exemplary preform 100 of FIGS. 1 and 2, may be used in conjunction with an abutment to provide a temporary restoration for a dental implant. U.S. patent application Ser. No. 12/371,563, incorporated herein by reference, discloses various exemplary abutments that may be used in accordance with the present teachings. FIG. 5 depicts an exemplary abutment 500 that may be used according to at least one embodiment of the present teachings. Abutment 500 includes an implant (or apical) end 580 that engages with an implant and a coronal end 590 that receives a restoration and/or other components configured to be secured to the abutment as will be set forth in more detail below. The abutment 500 may further include an implant engaging post 585 that includes the apical end 580 and comprises screw threading 510 configured to engage with complimentary screw threading on an internal surface of a dental implant.

Although screw threading 510 is shown in the exemplary abutment 500, those having ordinary skill in the art would understand that various other engagement mechanisms may be utilized in lieu of or in addition to screw threading to engage the post 585 of the abutment with a dental implant. For example, rather than screw threading, a non-threaded implant engaging post may be utilized that is received in a corresponding opening in the implant, with the abutment being tapped into secure engagement with the implant. By way of example, such posts may provide an anti-rotational and secure engagement of the abutment with the implant, for example, by being tapered and configured to fit within a similarly tapered opening in the implant, by having a lateral surface that is polygonal in cross-section (e.g., hexagonal or octagonal) and configured to fit within a similarly configured opening in the implant, or a combination thereof. Those ordinarily skilled in the art would be familiar with various types of engagement mechanisms that could be used to secure the abutment to the implant, including, for example various internal or external polygonal and anti-rotational surfaces, tapered surfaces, lobed channels, and/or combinations thereof. Depending on the type of engagement mechanism, therefore, the opening 515 for receiving a screw driver or other tool may not be needed.

The abutment 500 defines a substantially frustro-conical portion 540 extending from the implant engaging post 585 to a location about mid-way to about ⅔ of the length L of the abutment 500 measured from the apical end 580. The frustro-conical portion 540 of the abutment 500 has a peripheral outer surface that tapers. The frustro-conical portion 540 defines a shoulder 530 where the portion 540 meets the post 585. The frustro-conical portion 540 may be configured to engage with an internal frustro-conical seat region on a dental implant having any of a number of configurations with which those ordinarily skilled in the art are familiar.

As is also depicted in the exemplary abutment of FIG. 5, the abutment 500 includes a component supporting portion 550 extending from approximately mid-length to ⅔ the length L of the abutment 500 from the coronal end 590 to the apical end 580. The component supporting portion 550 may have a peripheral surface that tapers inwardly toward the end 590. As can be seen best in FIG. 5, the portion 550 also may include a flat surface portion 520 configured to assist in preventing relative rotation of a restoration and/or other components and the abutment 500 during engagement therebetween. In various exemplary embodiments, the flat surface portion of the abutment may be disposed at a distance ranging from about 0.03 in. to about 0.065 in. from the centerline of the abutment, for example, the distance of the flat surface portion to the centerline of the abutment may be about 0.0492 in.

The exemplary abutment 500 also may include a longitudinal groove 535 on an external surface portion that is substantially opposite to the flat surface portion 520 and extends from the coronal end 590 in a direction along the length of the abutment. The groove 535 extends in a direction substantially along the length of the abutment 500 and provides a gripping region for a tool used to torque the abutment 500 into engagement with an implant.

Around the outer peripheral surface of the component supporting portion 550 of the abutment 500 is a retention feature 525 that extends in a direction substantially transverse to a longitudinal axis of the abutment 500. More specifically, in the exemplary abutment 500 shown in FIG. 5 the retention feature 525 is a retention groove that may be positioned at or just coronal to the widest cross-sectional portion of the abutment 500 substantially where the frustro-conical portion 540 and the component supporting portion 550 meet. The retention feature 525 may be configured to engage with one or more complementary features on a component to achieve a mechanical retention of the temporary restoration or other component on the abutment, such as, for example, a temporary coping and or other surface of a temporary restoration as will be described. In various exemplary embodiments, one or more retention features, such as, for example, retention groove 525, may be positioned along a length of the portion 550 that is located just above an implant in the coronal direction when the abutment 500 is in engagement with the implant and fully inserted in the implant in an operational position. In an exemplary embodiment, the one or more retention features may be positioned from about 0.025 in. to about 0.119 in. from the implant/abutment juncture. In other embodiments, retention feature 525 may comprise another structure capable of mechanically retaining a complementary feature, such as for example, indentations or protrusions.

In various exemplary embodiments, the retention groove 525 may have a radiused surface profile. The surface of the retention groove 525 may, for example, define a radius of curvature ranging from about 0.010 in. to about 0.060 in. The retention groove 525 in the exemplary embodiment of FIG. 5 extends about 270° around the outer peripheral surface of the abutment 500, for example, extending substantially around the entire periphery of the abutment 500 with the exception of the flat portion 520. In various exemplary embodiments, such a retention groove may have a height ranging from about 0.015 in. to about 0.040 in., for example, about 0.021 in. In an exemplary embodiment, the retention groove 525 may be machined to a depth ranging from about 0.001 in. to about 0.006 in., for example, 0.003 in.

Although the exemplary embodiment of FIG. 5 depicts a single retention groove 525, those having ordinary skill in the art will appreciate that two or more retention grooves separated by non-grooved portions also may be provided around the outer peripheral surface of portion 550 of the abutment, but substantially at the same axial location along the length of the abutment, and disposed at locations so as to enable one or more protrusions on a temporary restoration or temporary coping (or other component) to mechanically engage therewith. Moreover, retention features in accordance with various exemplary embodiments, rather than extending around all or a portion of the outer peripheral surface, could provide an indented relatively local radiused configuration configured to engage with one or more protrusions on a temporary restoration, including a temporary coping, or other component utilized with dental implant systems to provide a mechanical engagement to the abutment.

In various exemplary embodiments, the one or more retention features provided on the outer peripheral surface of the abutment may be positioned so as to be accessible just above, at, or just below the gumline, when an abutment is positioned in place relative to an implant in a patient's mouth. Such positioning of the retention feature(s) may facilitate engagement of a corresponding retention feature (e.g., a complementary indentation or protrusion) on a temporary restoration by, for example, making it easier to push the tissue out of the way during engagement and/or by making it easier to receive a sensation (such as, for example, tactile and/or auditory) confirming a snap-fit engagement between one or more complementary retention features. Placement closer to the tissue margin also may provide enhanced stability of the mounting of the component on the abutment by providing retention at a wider portion of the abutment that presents a larger retention surface area (e.g., the retention groove presents a relatively large surface area when placed close or at the widest portion of the abutment). Likewise, in cases where bonding, for example, by cement or other adhesive, of a temporary restoration or other component to the abutment may be desired, a greater surface area on the wider portion of the abutment may promote a more stable bonding. For abutments configured to be situated at or below the gumline, it may be desirable (although not necessary) to position the one or more retention grooves somewhat closer to the coronal end of the abutment than the groove 525 is disposed.

In accordance with various exemplary embodiments, the component supporting portion 550 may have a length ranging from about 4 mm (0.157 in.) to about 7 mm (0.276 in.), for example, about 4 mm, about 5.5 mm (0.216 in.) or about 7 mm. Likewise, abutments in accordance with various exemplary embodiments of the present teachings may have various diameters where the abutment 500 mates with the implant substantially at a location of the shoulder of the implant so as to be configured to mate with implants having various coronal neck diameters, such as, for example, coronal neck diameters of about 4.1 mm, about 4.8 mm, or about 6.5 mm.

The configuration (e.g., size and shape) of the retention feature, for example, whether in the form of one or more protrusion rings or one or more relatively localized protrusions on either the temporary restoration and/or the temporary coping, may be chosen based on the various considerations, such as, for example, the shape and size of one or more retention grooves with which the protrusion features are designed to engage, the retention force required to maintain a mating engagement, e.g., the amount of force required to remove the temporary restoration from the abutment, and/or the retention force desired between the abutment and temporary restoration. Likewise, the number and positioning of the retention features may vary and may be selected based on similar considerations; the number of retention features may range from one to more than one.

In various exemplary embodiments, the retention features, for example, in the form of a continuous protrusion ring and/or localized protrusions, may have a substantially convex profile with a radius of curvature ranging from about 0.015 in. to about 0.025 in., for example, about 0.02 in., and may protrude from the internal peripheral surface portion of the coping from about 0.002 in. to about 0.006 in., for example, about 0.004 in. The height of the protrusion features (e.g., as measured along the longitudinal axis direction of the temporary coping) may range from about 0.015 in. to about 0.040 in., for example about 0.021 in. Of course, those having ordinary skill in the art would understand that these dimensions are exemplary only and may vary depending on, for example, the dimensions of a retention groove with which the protrusion features are designed to engage in a snap-fit manner, the desired retention force between the protrusion features and such a retention groove, etc. By way of example, the one or more protrusion features on a temporary coping in accordance with various exemplary embodiments may be configured so as to provide substantially a 100% interference mating fit with a corresponding retention groove on an abutment with which the one or more protrusion features are desired to engage. By way of further example, the one or more protrusion features on a temporary coping may be configured so as to provide a force ranging from about 0.5 lb. to about 20 lb., such as, for example, 2.5 lb. to about 7 lb. to achieve a mating engagement, for example, via a snap-fit, with one or more retention grooves. In addition, the one or more protrusion features on a temporary coping may be configured so as to provide a force ranging from about 0.5 lb. to about 20 lb., such as, 10 lb. to about 20 lb., for example, about 15 lb., to disengage the protrusions from one or more retention grooves on an abutment (i.e., pull off the temporary coping from the abutment). The amount of force to engage or disengage the temporary coping would depend on desired strength of the fit, the length of time the temporary restoration will be used, and other patient-dependent factors, and as such, one skilled in the art would understand how to determine the appropriate engagement/disengagement strength.

Those having ordinary skill in the art would understand, however, that the dimensions of abutments and corresponding portions thereof may be modified in accordance with the present teachings in order to fit with various implant configurations, temporary coping configurations, temporary restoration configurations, and/or as desired to satisfy a particular patient and/or need; the dimensions set forth herein are non-limiting and exemplary only. For example, those ordinarily skilled in the art would appreciate a variety of abutment dimensions selected so as to mate with a variety of internal, conically-tapered implant configurations, with which those having ordinary skill in the art are readily familiar.

In various exemplary embodiments, the present teachings also contemplate angled abutments, for example, as described in U.S. application Ser. No. 12/371,563, incorporated by reference herein and to which this application claims priority, comprising one or more retention features configured to mate with one or more complementary features to achieve retention of various components to be secured thereto.

According to at least one exemplary embodiment of the present teachings, a temporary restoration preform can be engaged with an underlying structure and adjusted to fit within the patient's mouth. Various methods in accordance with the present teachings contemplate the use of temporary restoration preforms having different amounts of hardened material initially present within the preform. Methods according to the present teachings may utilize temporary restoration preforms that comprise a hardenable malleable material, a hardened material, or a combination of hardenable malleable material and hardened material.

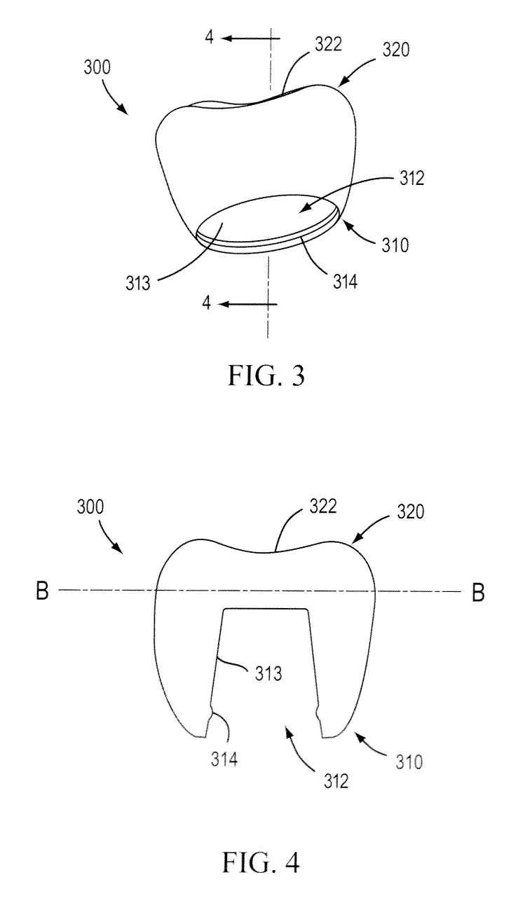

In at least one method according to the present teachings, the temporary restoration preform can be engaged with an abutment such as abutment 500 as described above. According to at least one embodiment, the temporary restoration preform 300 as shown in FIGS. 3 and 4 is used to engage abutment 500. Temporary restoration preform 300 is at least partially comprised of a hardened material. Temporary restoration preform 300 comprises an apical end 310 having a hollow cavity 312 that comprises an inner engagement surface 313 and an engagement feature that is complementary to the retention features on an abutment; for example, protrusion 314 that is complementary to groove 525. Temporary restoration preform 300 further comprises a coronal end having an occlusal surface 322. In at least one embodiment, the apical end 310 of the preform 300 comprises a hardened material (eg., the portion below line B-B in FIG. 4) and a hardenable malleable material at the coronal end 320 (e.g., the portion above line B-B). One skilled in the art would readily appreciate the location and shape of line B-B that defines the hardened portion and malleable portion of the preform 300 may be adjusted according to the desired malleability or hardness of the temporary restoration or preform. In at least one embodiment, apical end 310 may be hardened by the manufacturer or hardened by a lab technician in a dental laboratory. In other embodiments, the dentist may harden or cure the apical end 310, for example, chairside while the preform 300 is in or out of the patient's mouth.

In at least one embodiment, apical end 310 may be hardened by forming or molding a hardenable malleable about an analog that has a retention feature identical to the abutment that the temporary restoration will be engaged with, and then at least partially hardened or cured to set the complimentary retention feature into the temporary restoration or preform. In at least one other embodiment, a preform, such as, for example, PROTEMP™ CROWN, may be acquired directly from the manufacturer in a malleable form. A dental professional may engage the preform 300 with abutment 500 in the patient's mouth and then mold the preform 300 about the retention feature (groove 525) of the abutment 500 to create a complimentary retention feature (protrusion ring 314), as shown in FIG. 6. While the retention feature of apical end 310 is shown as a protrusion ring 314 in FIGS. 3 and 4, one skilled in the art would readily appreciate that the retention feature may comprise any geometry capable of mechanically retaining the temporary restoration or preform 300 to the underlying structure. When retention feature 314 is in a hardened form, a snap-fit engagement that may provide an audible or tactile sensation when engaging with the abutment may be possible and may eliminate the need for cement or other conventional adhesives.

If the coronal end 320 of temporary restoration 300 comprises a hardenable malleable material, the coronal end 320, including occlusal surface 322, may be adjusted in situ by molding the malleable material. Once the malleable material of coronal end 320 has been adjusted, the hardenable malleable material may be at least partially hardened. The malleable material of coronal end 320 may be hardened before, after, or at the same time the material of apical end 310 is hardened in at least one embodiment, the malleable material of coronal end 320 is partially hardened inside the patient's mouth to an extent that the preform 300 may be disengaged from the underlying structure without deforming the t preform 300, and then the partially hardened material may be fully hardened outside of the patient's mouth.

In at least one embodiment, a temporary coping may be used in conjunction with a temporary restoration preform to create a temporary restoration configured for engagement with an abutment. A cutaway side view of a temporary restoration preform 1200 engaged with an underlying structure comprising a temporary coping 1270 on abutment 500 is shown in FIG. 12. Temporary coping 1270 may be used as a spacer between abutment 500 and temporary restoration preform 1200, which may be desirable to increase the height of the temporary restoration preform 1200 above the gumline, such as when an implant is placed below the gumline. As shown in FIG. 12, temporary coping 1270 comprises an outer surface 1272 that contacts inner engagement surface 1213 of hollow cavity 1212 of the temporary restoration preform 1200. Temporary coping 1270 further comprises an inner surface 1274 having a retention feature 1275 that engages with complimentary retention feature 525 of abutment 500. Although not shown in FIG. 12, outer surface 1272 of temporary coping may further comprise retention features that engage with complementary features on an inner surface of the temporary restoration preform 1200. In at least one embodiment, temporary coping 1270 may comprise a bis-acrylic material (e.g., PROTEMP™ PLUS) as disclosed in U.S. patent application Ser. No. 12/332,524, incorporated by reference herein and to which this application claims priority. When the temporary coping 1270 and the preform 1200 both comprise a bis-acrylic material, it may be possible to form a chemical bond between the temporary coping 1270 and the preform 1200 that may eliminate the need for cement or other bonding agents.

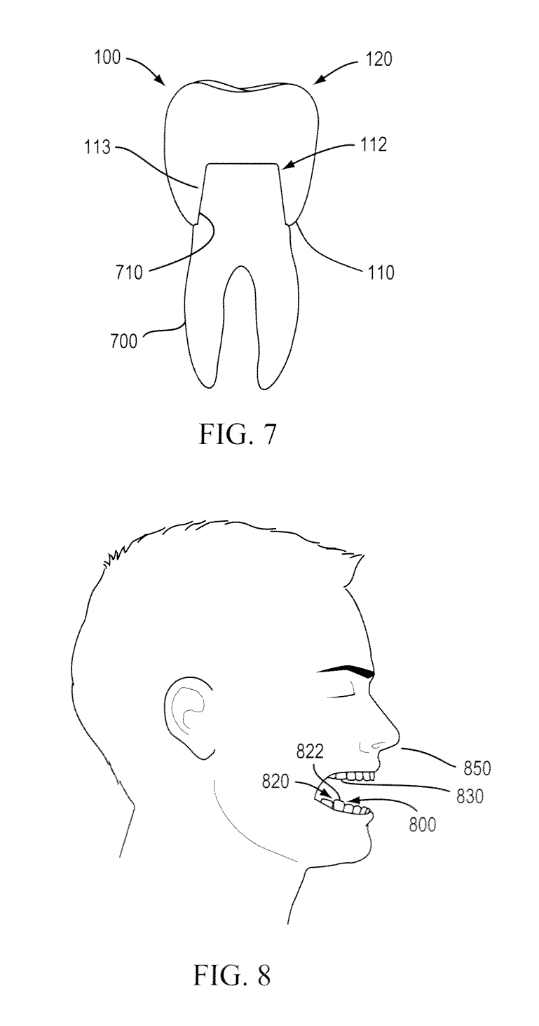

In accordance with at least one embodiment of the present teachings, the temporary preform may be used to form a temporary restoration over an underlying structure that comprises a prepared tooth. With reference to FIG. 7, the temporary restoration preform 100 of FIGS. 1 and 2 is shown engaged with a prepared tooth 700. As shown in FIG. 7, inner engagement surface 113 engages with shaped surface 710 of prepared tooth 700. In at least one embodiment, apical end 110 of the preform 100 at least partially comprises a hardened material, as depicted in FIG. 2. Coronal end 120 may comprise a hardenable malleable material, a hardened material, or a combination thereof. In at least one embodiment, coronal end 120 comprises a hardenable malleable material.

The hollow cavity 112 of the preform 100 may be shaped to approximately fit the shaped surface 710 of prepared tooth 700. In at least one embodiment, a hardenable flowable material may be disposed within hollow cavity 112 prior to engagement with the prepared tooth 700 to create a tighter or more robust fit between the temporary restoration preform 100 and the prepared tooth 700. In at least one embodiment, the hardenable flowable material comprises a bis-acrylic material (e.g., PROTEMP™ PLUS) and the temporary restoration or preform comprises a bis-acrylic material (e.g., PROTEMP™ CROWN). When both materials comprise a bis-acrylic material, the hardenable flowable material may form a chemical bond with the temporary restoration or preform that may eliminate the need for cement or other bonding agent. Conventional temporary cements or bonding agents may be used to bond the temporary restoration or preform 100 to the prepared tooth 700.

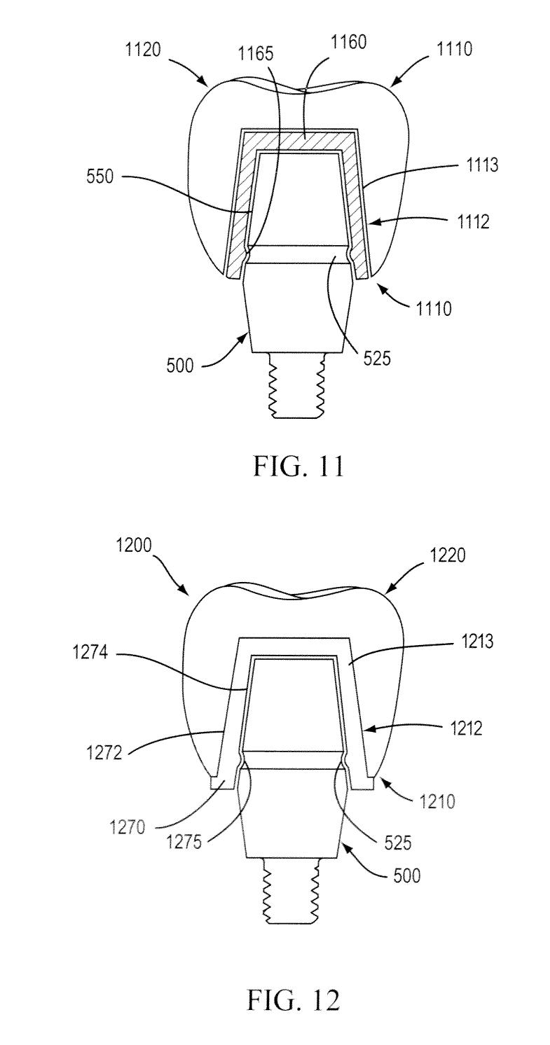

The hardenable flowable material described above may also be used in embodiments where the temporary restoration or preform is engaged with an abutment. FIG. 11 is a cutaway side view of a temporary restoration preform 1100 engaged with abutment 500 through the use of a hardenable flowable material 1160. Apical end 1110 of the preform 1100 has an opening leading to a hollow cavity 1113 that is defined by an inner engagement surface 1113. The preform 1100, including for example at least the apical end 1110, can at least partially comprise a hardened material A hardenable flowable material, such as, for example, PROTEMP™ PLUS, may be disposed within the hollow cavity 1112 prior to engagement with the abutment 500. As the temporary restoration or preform 1100 is engaged with the abutment 500, the hardenable flowable material flows around the abutment and fills retention feature 525 to create a complementary retention feature 1165. When the hardenable flowable material 1160 hardens, a snap-fit engagement may be created between the temporary restoration preform 1100 and the abutment 500. In at least one embodiment, hardenable flowable material 1160 comprises a bis-acrylic material (e.g., PROTEMP™ PLUS) and the temporary restoration preform 1100 also comprises a bis-acrylic material (e.g., PROTEMP™ CROWN). When both the hardenable flowable material and the temporary restoration preform comprise bis-acrylic materials, it may be possible to form a chemical bond between the hardenable flowable material and the temporary restoration preform

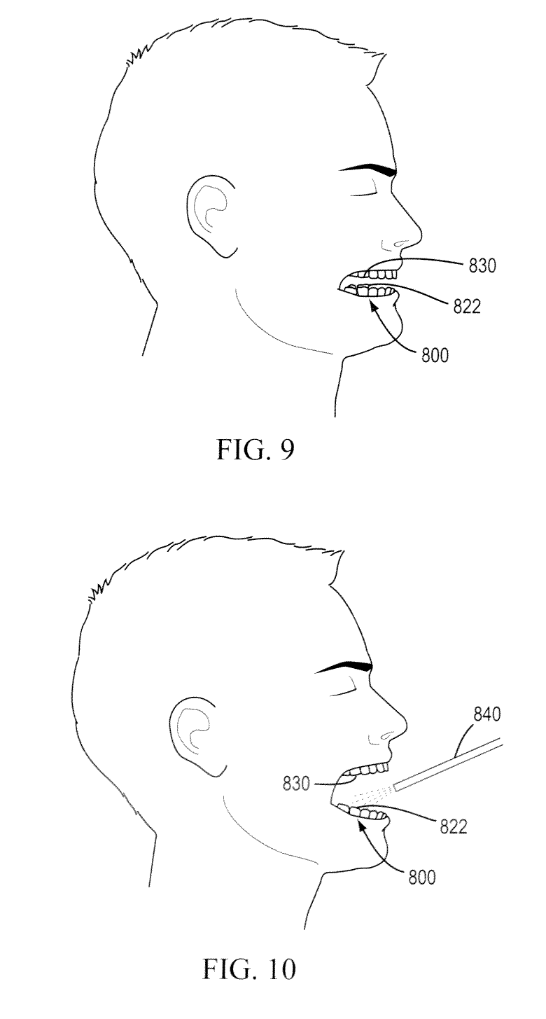

According to various exemplary embodiments of the present teachings, temporary restorations preforms having a coronal end comprising a hardenable malleable material may provide for a simplified method of adjusting the occlusal, buccal, and lingual surfaces of the preform prior to hardening the material. FIGS. 8-10 depict an exemplary method for adjusting the occlusal surface 822 of a temporary restoration preform 800 according to at least one embodiment in accordance with the present teachings. In FIG. 8, temporary restoration preform 800 is shown engaged in the mouth of a patient 850 (either with an abutment directly or via a coping, or with a prepared tooth). The coronal end 820 of the temporary restoration preform 800 comprises a hardenable malleable material. As shown in FIG. 9, the occlusal surface 822 of the temporary restoration preform 800 may be adjusted in situ by having the patient 850 close her mouth. The tooth 830 on the jaw opposite the temporary preform 800 presses against the occlusal surface 822, thereby shaping the preform 800 to the geometry of the patient's teeth. The dentist may further adjust the buccal and lingual surfaces of the preform 800 by shaping the malleable material by hand or with conventional shaping tools. After all desired adjustments have been made, the hardenable malleable material may be at least partially hardened in situ or outside the patient's mouth. Once the temporary restoration preform 800 has been at least partially hardened in situ, it may be removed if desired and hardened completely without deforming the preform 800 to create the temporary restoration. Alternatively, the preform 800 may be entirely hardened in situ, for example, by curing using a UV light source, such as UV light 840 shown in FIG. 10.

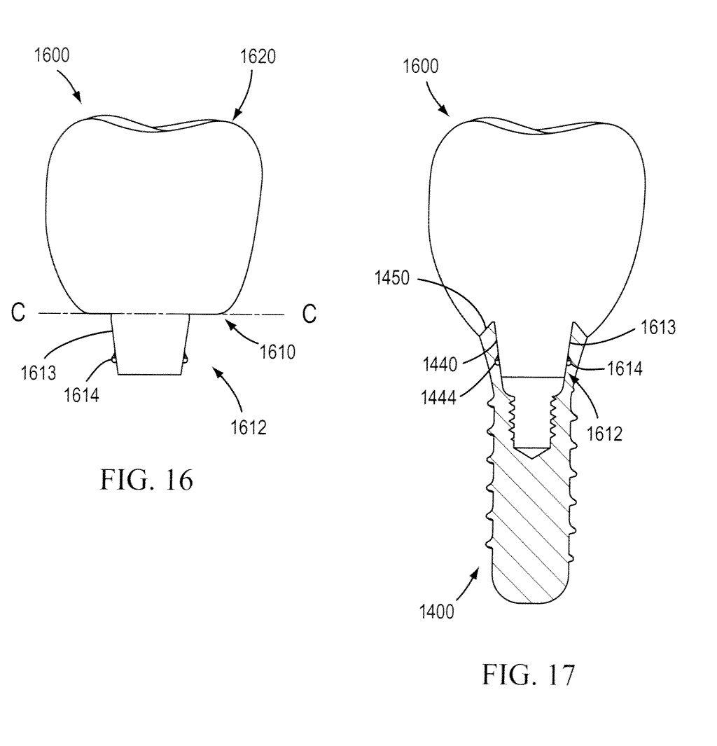

In at least one embodiment according to the present teachings, the preform may comprise a post configured to be received in an opening of an underlying structure instead of the underlying structure being received within a hollow cavity of the preform, as described in various exemplary embodiments above. FIG. 16 shows an exemplary embodiment of a preform 1600 comprising an apical end 1610 and a coronal end 1620. Apical end 1610 comprises a post 1612 having an outer engagement surface 1613. In at least one embodiment, outer engagement surface 1613 may comprise a retention feature, such as, for example, one or more protrusions 1614, complementary to a retention feature, such as, for example, one or more indentations (e.g., groove 1444 shown in FIGS. 14 and 17) on the underlying structure. In at least one embodiment, the apical end 1610 of the preform 1600 comprises a hardened material (e.g., the portion below line C-C in FIG. 16) and a hardenable malleable material at the coronal end 1620 (e.g., the portion above line C-C). One ordinarily skilled in the art would readily appreciate that the location and shape of line C-C that delineates the hardened portion and malleable portion of the preform 1600 may be adjusted according to the desired malleability or hardness of the preform.

According to at least one embodiment, outer engagement surface may be indexed (e.g., defining a polygonal periphery) to securely engage the underlying structure, such as an implant 1400, as shown in FIG. 14. Implant 1400 comprises an apical end 1410 and a coronal end 1420. Coronal end 1420 comprises a shoulder region 1450 and an inner cavity 1430. Inner cavity 1430 has an inner indexed engagement surface 1440, which comprises a retention feature in the form of retention groove 1444. As shown in FIG. 15, inner indexed engagement surface 1440 may define a polygonal periphery corresponding to that of the outer surface of post 1613. FIG. 17 shows preform 1600 in engagement with implant 1400. The protrusion 1614 of preform 1600 fittingly engages groove 1444 of implant 1400, and projection 1612 engages with the inner indexed engagement surface 1440.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and al subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the devices and methods of the present disclosure without departing from the scope its teachings. By way of example, various dimensions, shapes, materials, and/or arrangements of parts may be altered based on desirable features and/or applications, and those having ordinary skill in the art would recognize how to make such modifications in light of the present teachings. By way of example, although in the exemplary embodiments shown and described above, the protrusion features, whether localized or in the form of protrusion rings, have generally radial profiles (e.g., semi-spherical), those having ordinary skill in the art that would understand that various shapes and configurations of protrusion features, including but not limited to, for example, rectangular, cubical, pyramidal, etc. may be used without departing from the scope of the present teachings. In addition, although in the exemplary embodiments above, various retention features are shown and described as radiused grooves having a substantially arc-shaped profile, those having ordinary skill in the art would understand that such grooves could have a variety of shapes, including, but not limited to, for example, notch-shaped (e.g., V-shaped), or presenting multiple sides. Moreover, in various exemplary embodiments disclosed herein and in parent U.S. application Ser. No. 12/371,563, incorporated by reference in its entirety herein, abutments and/or analogs and various components (e.g., impression copings, temporary copings, burnout copings, permanent copings, and/or preforms are configured with complementary retention features configured to engage, such as, for example, in a snap-fit or interference fit manner to retain the various components in mating engagement with the abutment and/or analog. In various exemplary embodiments, the complementary retention features are illustrated and disclosed as an indentation or groove provided on the abutment and/or analog, and a protrusion feature provided on the mating component. However, the one or more protrusion features may be positioned on the abutments and/or analogs disclosed herein and in parent U.S. application Ser. No. 12/371,563, and the complementary retention features in the form of indentations or grooves may be provided on the various components configured to be retained in mating engagement with the abutments and/or analogs.

In the exemplary embodiments described above, various features have been discussed. Those having ordinary skill in the art would recognize that in some cases, features described with respect to one exemplary embodiment may be combined and/or used in conjunction with another exemplary embodiment even if not specifically described herein. The present teachings are intended to cover such modifications and combinations as would be apparent to those ordinarily skilled in the art.

The various exemplary embodiments described and shown herein are not intended to limit the present teachings. To the contrary, the present teachings are intended to cover alternatives, modifications, and equivalents. Other embodiments of the present teachings will be apparent to those skilled in the art from consideration of the specification and practice of the present teachings disclosed herein. It is intended that the specification and exemplary embodiments be considered as exemplary only with the claims being provided a scope of a breadth supported by the present teachings.

What is claimed is:

1. A temporary restoration preform for use in a patient's body, comprising:
an apical end;
a coronal end opposite the apical end; and
a portion configured to engage with an underlying structure for retention thereto,
wherein a first portion of the preform comprises a hardened material and a remaining portion of the preform comprises a hardenable malleable material.

2. The temporary restoration preform of claim 1, wherein the underlying structure is chosen from an abutment, a temporary coping, an implant, and a prepared tooth.

3. The temporary restoration preform of claim 1, wherein the hardened material and the hardenable malleable material are the same material.

4. The temporary restoration preform of claim 3, wherein the hardened material and the hardenable malleable material comprise a bis-acrylic material.

5. The temporary restoration preform of claim 1, further comprising at least one retention feature configured to engage a complimentary retention feature of the underlying structure.

6. The temporary restoration preform of claim 5, wherein the at least one retention feature comprises at least one protrusion.

7. The temporary restoration preform of claim 1, wherein the coronal end comprises hardenable malleable material.

8. The temporary restoration preform of claim 7, wherein the coronal end comprises a light-curable or heat-curable malleable material.

9. The temporary restoration preform of claim 1, wherein the hardenable malleable material comprises a bis-acrylic material.

10. The temporary restoration preform of claim 1, wherein the portion configured to engage with the underlying structure comprises a hollow cavity or a post configured to engage with the underlying structure

11. A method for fitting a temporary restoration in a patient, comprising:
providing a temporary restoration preform comprising an apical end, a coronal end, and a portion configured to engage an underlying structure for retention thereto, wherein the apical end comprises a hardened material and the coronal end comprises a hardenable malleable material;
engaging the temporary restoration preform with the underlying structure; and
hardening the hardenable malleable material to form a temporary restoration in a patient's mouth.

12. The method of claim 11, wherein engaging the temporary restoration preform with the underlying structure comprises engaging the temporary restoration preform with one of an abutment, a temporary coping, an implant, and a prepared tooth.

13. The method of claim 11, wherein the underlying structure comprises at least one retention feature.

14. The method of claim 13, wherein the temporary restoration preform comprises a hardened material having at least one complementary retention feature, and wherein engaging the underlying structure comprises fittingly engaging the at least one retention feature of the of the temporary restoration preform with the at least one retention feature of the underlying structure.

15. The method of claim 11, further comprising adjusting the hardenable malleable material of the coronal end prior to hardening the hardenable malleable material.

16. The method of claim 11, wherein the hardened material and the hardenable malleable material comprise a bis-acrylic material.

17. The method of claim 16, further comprising applying a hardenable flowable bis-acrylic material to the portion of the temporary restoration preform prior to engagement with the underlying structure.

18. The method of claim 15, wherein adjusting the hardenable malleable material comprises having the patient bite down on an occlusal surface of the coronal end.

19. The method of claim 11, wherein the portion configured to engage the underlying structure comprises a hollow cavity or a post configured to engage the underlying structure.

20. A method for fitting a temporary restoration in a patient, comprising:
providing a temporary restoration preform comprising a hardenable malleable material, wherein the temporary restoration preform comprises an apical end, a coronal end, and a hollow cavity configured to receive an abutment;
inserting an abutment comprising a retention feature on an outer surface thereof into the hollow cavity;
adjusting the hardenable malleable material about the retention feature of the abutment to form a complementary retention feature on an inner engagement surface defining the hollow cavity; and
at least partially hardening the hardenable malleable material.

21. A kit for making dental restorations, the kit comprising:
an abutment comprising an implant engaging portion and a component supporting portion, the implant engaging portion being configured to engage with a dental implant and the component supporting portion comprising at least one retention feature disposed on an outer peripheral surface of the component supporting portion; and
a temporary restoration preform comprising a hardened malleable material, wherein the temporary restoration preform comprises an apical end, a coronal end, and a hollow cavity configured receive the component supporting portion.

22. The kit of claim 21, wherein the apical end comprises an inner engagement surface within the hollow cavity having at least one complementary retention feature to fittingly engage the at least retention feature of the component supporting portion.
